(19) United States
(12) Patent Application Publication
(10) Pub. No.: US 2018/0330367 A1
(43) Pub. Date: Nov. 15, 2018

(54) MOBILE PAYMENT SYSTEM AND PROCESS

(71) Applicant: Mastercard International Incorporated, Purchase, NY (US)

(72) Inventor: Piyush Sharma, Pune (IN)

(73) Assignee: Mastercard International Incorporated, Purchase, NY (US)

(21) Appl. No.: 15/967,204

(22) Filed: Apr. 30, 2018

(30) Foreign Application Priority Data
May 11, 2017 (SG) 10201703868P

(51) Int. Cl. G06Q 20/38; G06Q 20/32; G06Q 20/34; G06Q 20/40

(52) U.S. Cl. CPC G06Q 20/385; G06Q 20/322; G06Q 20/3274; G06Q 20/4012; G06Q 20/3829; G06Q 20/34

(57) ABSTRACT

The described embodiments of the present invention include a secure mobile payment system and process for performing electronic payment transactions from a payment account of an associated payment card of a user, where the payment is conducted using a mobile computing device. Specifically, the system and processes described herein (referred to as the “Secure Mobile Payment” (SMP) system and processes) allows a customer (referred to as a “user” of the system) to register with the system, and to nominate one or more of their credit or debit payment cards for which secure electronic payments are permitted to be performed with. Each payment card is associated with a particular card entity (such as MasterCard), and a corresponding financial institution (referred to herein as an “issuer”). Following registration with the system, the user is able to perform a transaction on a payment account associated with a particular payment card, without physical access to that card, via a mobile computing device of the user (a “user device”).

### CROSS-REFERENCE TO RELATED APPLICATIONS

This application claims the priority of Singapore Application Serial No. 10201703868P, filed May 11, 2017, which is incorporated herein by reference in its entirety.

### TECHNICAL FIELD

The present invention relates to a mobile payment system and process for performing secure payment transactions from a mobile computing device.

### BACKGROUND

The use of electronic payment services has increased dramatically in recent decades. In particular, credit and debit card-based payment services have become integrated into everyday life due to their ability to allow a customer to complete purchases via the electronic transfer of funds from a payment account to a merchant's account. Card-based payments offer many advantages over cash payments, including that the customer can transfer funds to a merchant in any currency without needing to transport physical denominations or having to manually perform conversions from one currency type to another, while retaining the efficiency of a cash exchange. More recently, mobile payment services (e.g. Paypal, ApplePay, Android Pay, etc.) have been developed to allow customers to make payments without a physical credit or debit card, through the use of a portable mobile device, such as a smartphone. These services act as a “digital wallet” by storing the details of a customer's payment account and allowing the customer to make electronic payments from the account to a merchant without requiring the use of a physical card that is associated with the account.

As a result of the wide spread adoption of mobile computing devices, it is often desirable to perform electronic payments with a mobile computing device (referred to herein as a “mobile payment”) in a secure manner. Conventional mobile payment services require the use of a payment application which resides on the mobile device of a user and stores identification and/or payment account details of the user. Once the user successfully authenticates themselves with the mobile payment application, the payment application can be used to perform an electronic payment in place of the physical card associated with the account.

Despite the popularity of these services, there are some shortcomings with existing mobile based electronic payment technologies. A characteristic of conventional digital wallet type services is their use of wireless communication to transmit payment account information to the corresponding payment device. Specifically, traditional digital wallet services use Near-Field Communication (NFC) to transfer the payment account information to a Point-of-Sale (POS) device of a merchant in order to perform a mobile payment transaction. The wireless communication of payment information is problematic in that it is susceptible to interference which can reduce the effectiveness of, or in some cases prevent, the transfer of the payment information, and consequently cause the transaction to fail. The likelihood of interference is constantly increasing as mobile device adoption increases, due to the increase in the number of devices which transmit wireless communication signals within a given area. Second, NFC based communication is vulnerable to interception by a third party within the vicinity of the transmission. This can allow an unauthorised party to eavesdrop signals transmitted from the user's mobile device during a mobile payment, and consequently ascertain the user's payment account information.

A more fundamental drawback of existing mobile payment services is the lack of control available to a user to constrain the conditions under which mobile payments may be performed with particular payment cards. For example, in a conventional digital wallet application, the user only needs to log into the application in order to use a payment card that has been added to, or associated with, the wallet for any number of arbitrary payment transactions (i.e. without requesting or generating any particular credentials for each successive transaction).

However, a user may desire to place constraints on the payments performed with the payment account of a corresponding payment card, as conducted from their mobile device. For example, the user may wish to allow mobile payments to be performed only for a particular period of time, or to limit the number of transactions that can be performed before subsequent operation of the mobile payment application is required. This is not possible using conventional “one-step” payment services which allow full access to a user's payment account from a device executing a mobile payment application, once the payment card of that account is added to the application.

US 20150178721 discloses use of dynamically generated quick response (QR) codes for secure communication to/from mobile devices. In one example, a QR code identifies a product or service selected by a user using a mobile device. The mobile device generates the QR code identifying the user's selection, and displays the QR code for reading by a retail kiosk. The retail kiosk, such as movie-rental kiosk, extracts the product or service selection encoded in QR code and provides the identified product or service to the user. However, the use of only the QR code does not ensure security of the communication. The QR code can be compromised and the communication will be adversely affected.

Despite the convenience of these payment technologies, there remains room for improvement. It is desired to provide a system and process for secure mobile payments that alleviates one or more difficulties of the prior art, or to at least provide a useful alternative.

### SUMMARY

In a first aspect, there is provided a user device, including at least one computing device being configured to make a payment from a payment card by carrying out the steps of: generating, at the user device, payment card data representing a payment card linked to a payment account of a user, said payment card associated with a card entity and issued by an issuing financial institution; processing, at the user device, the payment card data to generate mobile payment initiation request data requesting mobile payment credentials data for performing a transaction with the payment account; and transmitting, to a card entity server, the mobile payment initiation request data, such that the mobile payment credentials data are received at the user device. It is preferable that the transaction can be performed at a payment device when a payment account identifier and a corresponding dynamically generated security code, both of the mobile payment credentials data, are presented to the payment device.

In a second aspect, there is provided a data processor implemented process for making a payment from a payment card, the process being executed by at least one processor, and including: generating, at a user device, payment card data representing a payment card linked to a payment account of a user, said payment card associated with a card entity and issued by an issuing financial institution; processing, at the user device, the payment card data to generate mobile payment initiation request data requesting mobile payment credentials data for performing a transaction with the payment account; transmitting, to a card entity server, the mobile payment initiation request data from the user device; and receiving, at the user device, the mobile payment credentials data. It is preferable that the transaction can be performed at a payment device when a payment account identifier and a corresponding dynamically generated security code, both of the mobile payment credentials data, are presented to the payment device.

There is also provided a card entity system, including at least one computing device being configured to authorise a mobile payment initiation request by carrying out the steps of: receiving, from a user device, mobile payment initiation request data requesting mobile payment credentials data for performing a transaction with a payment account of a user, said payment account linked to a payment card associated with a card entity and issued by an issuing financial institution; processing the received mobile payment initiation request data to generate mobile payment credentials data for performing a transaction with the payment account; and transmitting, to the user device, the mobile payment credentials data, such that the payment can be performed at a payment device when a payment account identifier and a corresponding dynamically generated security code, both of the mobile payment credentials data, are presented to the payment device.

In a further aspect, there is provided a data processor implemented process for conducting a payment transaction made on a payment card, the process being executed by at least one processor, and including: receiving, at a card entity server, from a payment device: i) transaction information data representing a payment transaction requested in respect of a payment account of a user, said payment account associated with the payment card; and ii) payment credentials data representing a payment account identifier of the payment account and a corresponding dynamically generated security code; processing, at the card entity server, the payment credentials data and the transaction information data to produce validity data indicating whether the payment transaction specified by the transaction information data can be validly performed, the validity data based on an indication of the prior authorisation of the transaction with the payment account; generating, at the card entity server, if the payment transaction is valid, financial transaction data representing a standard financial transaction message for conducting the payment transaction; transmitting, from the card entity server, the standard financial transaction message to the issuing financial institution for processing, and receiving corresponding response data indicating the success or failure of the payment transaction; and transmitting the response data from the card entity server to the payment device to allow completion of the payment transaction.

Furthermore, there is provided a card entity system, including at least one computing device being configured to conduct a payment transaction made with a payment card by carrying out the steps of: receiving from a payment device: i) transaction information data representing a payment transaction requested in respect of a payment account of a user, said payment account associated with the payment card; and ii) payment credentials data representing a payment account identifier of the payment account and a corresponding dynamically generated security code; processing the payment credentials data and the transaction information data to produce validity data indicating whether the payment transaction specified by the transaction information data can be validly performed, the validity data based on an indication of the prior authorisation of the transaction with the payment account; generating if the payment transaction is valid, financial transaction data representing a standard financial transaction message for conducting the payment transaction; transmitting the standard financial transaction message to the issuing financial institution for processing, and receiving corresponding response data indicating the success or failure of the payment transaction; and transmitting the response data to the payment device to allow completion of the payment transaction.

In a final aspect, there is provided a user device, including at least one computing device being configured to make a payment from a payment card by carrying out the steps of: generating, at the user device, payment card data representing a payment card linked to a payment account of a user, said payment card associated with a card entity and issued by an issuing financial institution; processing, at the user device, the payment card data to generate mobile payment initiation request data requesting mobile payment credentials data for performing a transaction with the payment account; and transmitting, to a card entity server, the mobile payment initiation request data, such that the mobile payment credentials data are received at the user device. Preferably, the transaction can be performed at a payment device when a payment account identifier and a corresponding dynamically generated security code, both of the mobile payment credentials data, are presented to the payment device, the payment account identifier and the corresponding dynamically generated security code being a different pairing for every instance of payment.

### BRIEF DESCRIPTION OF THE DRAWINGS

Some embodiments of the present invention are hereinafter described, by way of example only, with reference to the accompanying drawings, wherein:

FIG. 1 is a block diagram of a secure mobile payment system in accordance with some embodiments of the present invention;

FIG. 2 is a block diagram of a computing device within the secure mobile payment system;

FIG. 3 is a flow diagram of a process for performing a secure mobile payment transaction in accordance with some embodiments of the present invention;

FIG. 4 is a flow diagram of a process for user registration of the secure mobile payment transaction process;

FIG. 5 is a flow diagram of a process for generating a secure mobile payment card list of the secure mobile payment transaction process;

FIG. 6 is a flow diagram of a process for generating the mobile payment parameter data of a secure mobile payment transaction in accordance with some embodiments of the present invention;

FIG. 7 is a flow diagram of a secure mobile payment initiation request process in accordance with some embodiments of the present invention;

FIG. 8 is a flow diagram of a process for generating payment credentials data of the secure mobile payment initiation request process;

FIG. 9 is a flow diagram of a process for conducting an authorised secure mobile payment transaction at a payment device in accordance with some embodiments of the present invention; and

FIG. 10 is a flow diagram of a process for conducting an authorised secure mobile payment transaction at a card association entity device in accordance with some embodiments of the present invention.

### DETAILED DESCRIPTION

The described embodiments of the present invention include a secure mobile payment system and process for performing electronic payment transactions from a payment account of an associated payment card of a user, where the payment is conducted using a mobile computing device. Specifically, the system and processes described herein (referred to as the “Secure Mobile Payment” (SMP) system and processes) allows a customer (referred to as a “user” of the system) to register with the system, and to nominate one or more of their credit or debit payment cards for which secure electronic payments are permitted to be performed with. Each payment card is associated with a particular card entity (such as MasterCard), and a corresponding financial institution (referred to herein as an “issuer”). Following registration with the system, the user is able to perform a transaction on a payment account associated with a particular payment card, without physical access to that card, via a mobile computing device of the user (a “user device”).

The user is able to enable a secure mobile payment on a selected payment card using a SMP application which communicates with the card entity and/or issuer. The mobile payment is enabled by the transmission, from the card entity to the user device, of secure mobile payment credentials (SMP credentials) including: an identifier representing the payment account information of the selected payment card in an encapsulated form; and a one-time password (OTP) security code, which permits a transaction to be performed on the payment account. The user can present the identifier and enter the corresponding OTP code into an Automatic Teller Machine (ATM) or POS device in order to complete a cash withdrawal, or a POS payment, using the account of the selected payment card.

Interaction between the user's mobile device and the payment device is based on a plurality of QR code identifiers in the described embodiments. The security code is in the form of an OTP password which is generated by the card entity dynamically at the time at which a SMP initiation request is received from the user. Alternatively, the system can be configured to allow the user of the PIN value of the corresponding payment card as the security code during a secure mobile payment. The SMP application displays the QR code such that, when presented to the payment device, the payment device is able to read the code and obtain the information required to perform the payment transaction with the selected payment card account. The skilled addressee will appreciate that other identifiers may be used in alternative embodiments to encapsulate the payment account information, such as barcodes or other sequences of symbols and/or characters. It is noted that the concepts described herein in relation to performing secure mobile payments are equally applicable to such alternative embodiments.

The user operates the secure mobile payment system via a secure mobile payment software application executed on the user device. In some embodiments, the secure mobile payment software application is a dedicated mobile application obtained by the user via a mobile application distribution store (such as Google Play Store or Apple Store). In other embodiments, the SMP Application is a generic web browser application configured to render web pages of an Internet Banking Service (IBS) of the issuer. Requests to initiate a secure mobile payment in respect of a selected payment card can be transmitted indirectly to the card entity via the issuer IBS, and the corresponding SMP credentials are delivered to the browser application via the IBS.

The secure mobile payment application allows the user to select a payment card from a list of payment cards (“SMP cards”) that support secure mobile payments for the user. The payment can be a cash withdrawal or a POS purchase performed at ATM or POS payment devices respectively. The payment devices of the SMP system are standard ATM or POS devices configured to interface with the a mobile device for the purpose of obtaining the details of the payment account corresponding to the card selected by the user. Following authentication by the user at the ATM or POS device, and verification by the card entity that a secure mobile payment is authorised for the account, processing of the transaction proceeds according to standard procedures for financial message generation and transmission. This allows the SMP system and process described herein to integrate with existing ATM and POS terminals, and with the current transaction processing systems deployed by issuers.

The generation of payment identifier and security code information is performed dynamically by the card entity, such that a different identifier and code pair may be generated for successive SMP initiation requests in respect of the same payment account. The payment identifier and security code allow mobile payments to be performed for a particular payment account subject to conditions or limitations. For example, a payment identifier and security code combination may only be valid for a particular period of time beginning at the generation of the combination, and may expire at the end of this period. Alternatively, or in addition, the identifier and code combination may only allow a certain number of transactions to be conducted with the selected payment account, and/or may only permit transactions with a transaction value less than or equal to a particular threshold value. This allows the user to exercise control over the circumstances in which mobile payments can be performed using the SMP system described herein.

In the described embodiments, the SMP system is configured to provide SMP credentials to the user device, in response to a SMP initiation request received from that device, for the purpose of allowing the user to perform a secure mobile payment transaction in respect of the selected payment card. Various modifications may be performed to the described embodiments such that the SMP system is configured to allow the user to designate the particular mobile device to which SMP credentials are transmitted. For example, in such a system the payment identifier and security code may be transmitted to a secondary device that differs from the user device which executes the SMP application operated by the user to initiate the SMP request.

The secure mobile payment system and process described herein therefore advantageously provide a platform for performing electronic payments with particular payment accounts that:
1) allows a user to make payments from a mobile device with a payment account, and without possessing the physical card associated with the account;
2) preserves the security of the payment account information of a user by, avoiding the use of wireless communication media for the transmission of encoded payment card information for the user device to a payment device, and by using separate authentication credentials to operate the mobile payment application and to perform the mobile payment;
3) enables the user to exercise control over the conditions in which mobile payments can be made using a particular payment card without placing restrictions on the card at the issuer level; and
4) supports the use of standard methods for ATM and POS based transaction processing, thus requiring minimal changes to the existing financial infrastructures of card association entities and issuing financial institutions.

### System

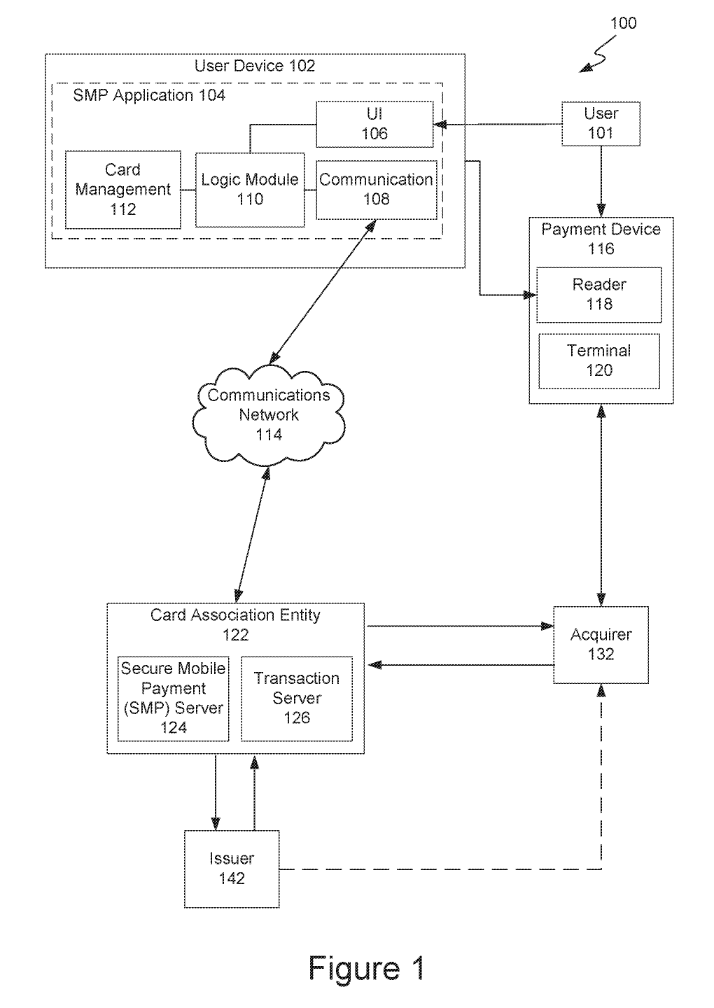

As shown in FIG. 1, the secure mobile payment (SMP) system 100 includes a user device 102, such as a smartphone, tablet or portable computer, operated by a user 101 in communication with a card entity 122 via a communications network 114. The user 101 operates the user device 102 for the purpose of making a payment with a payment card that is linked to the card entity 122, where the payment card (such as a credit or debit card) and associated payment account are owned by the user 101. In some embodiments, the payment is made by the user 101 via a payment device 116, which is configured to interact with the user device 102 via a reader 118. The reader 118 is configured to read or scan the user device 102 in order to identify the account from which the payment is to be made, and a terminal 120 of the payment device 116 is configured to accept: security verification input that verifies the authorisation of the user 101 to make a payment with the identified account; and transaction information, such as the transaction amount.

In the described embodiments, the payment device 116 is configured to communicate with the card entity 122 and/or acquirer 132 via the communications network 114. In other embodiments, the payment device 1116 can be configured to communicate directly with the acquirer 132 or card entity 122, such as, for example, in the case of an ATM that is physically connected to the secure local network of a financial institution.

The user device 102 executes a SMP application 104 which facilitates the process by which the user 101 can select a payment card to make a payment, request secure mobile payment credentials (“SMP credentials”) from the card entity 122 allowing the initiation of a secure mobile payment with the selected payment account, and conduct the payment at a payment device. The SMP application 104 of the described embodiments is a mobile application in the form of software modules including a user interface 106, a logic module 110, a communication module 108 and a card management module 112, as described below. In some embodiments, the SMP application 104 is a stand alone application provided by the card entity 122 via an online application store (such as Google Play). In other embodiments, the SMP application 104 is a mobile web browser application configured to access an Internet Banking Service (IBS) of the issuer 142. In these embodiments, information is exchanged between the user device 102 and the card entity 122 via the IBS of the issuer 142.

The user device 102 receives secure mobile payment credentials (“SMP credentials”) from the secure mobile payment server (“SMP server”) 124 of the card entity 122 to make a payment from a payment account of a corresponding payment card of the user 101. The corresponding payment card is a payment card that is selected from a list of available payment cards of the user 101, and associated with the card entity 122, that are eligible to perform secure mobile payment transactions (referred to as “SMP cards”). The SMP credentials are exchanged via communication between the SMP server 124 and the user mobile device 102 via the communications network 114. In the described embodiments, the communications network 114 is a single network, however in other embodiments the network 114 may include a plurality of different sub-networks. Specifically, communication between the user device 102 and the card entity 122 is conducted over local or wide area networks, via Internet data transfer protocols. The skilled addressee will appreciate that, in other embodiments, communication between the user mobile device 102 and the SMP server 124 of the card entity 122 may occur over the telephone network, such as via SMS, as facilitated by a software application executing on the user mobile device 102.

The card entity 122 further includes a transaction server 126 configured to communicate with the issuer 142 of a payment account in respect of a mobile payment that is requested on this account. The processing of payment transactions by the card entity 122, and the communication occurring between the card entity 122, the issuer 142, and the acquirer 132 is in accordance with standard financial payment system processes.

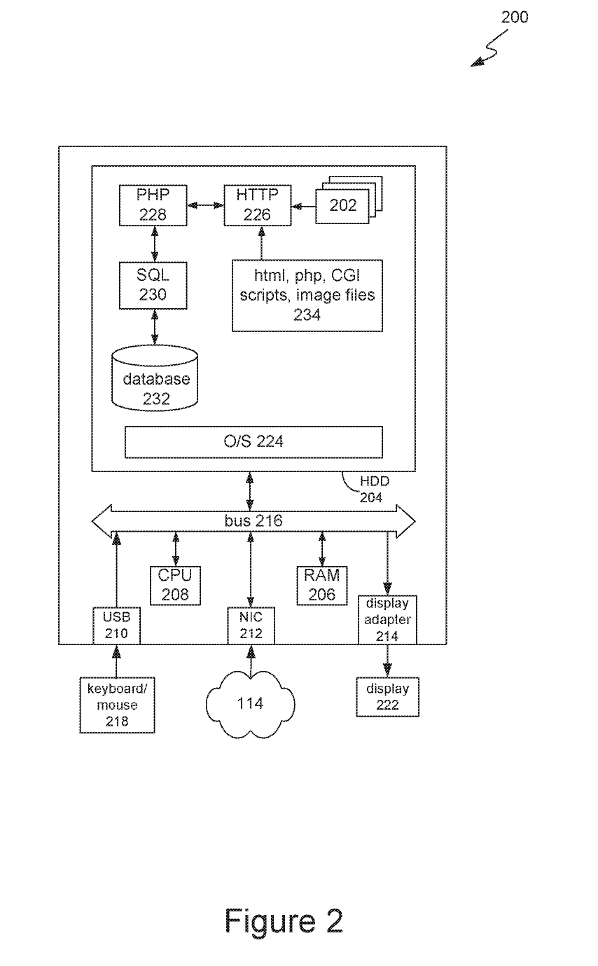

In the described embodiments of the SMP system 100, the user device 102, payment device 116, card entity 122 devices (including the SMP server 124 and transaction server 126), acquirer 132 devices, and issuer 142 devices are standard computer systems 200 such as, for example, an Intel IA-32 based computer system, as shown in FIG. 2, and the processes 300, 700 and 900 executed by the system 200 are implemented as programming instructions of one or more software modules 202 stored on non-volatile (e.g., hard disk or solid-state drive) storage 204 associated with the computer system. However, it will be apparent that at least parts of the aforementioned processes could alternatively be implemented as one or more dedicated hardware components, such as application-specific integrated circuits (ASICs) and/or field programmable gate arrays (FPGAs), for example.

The system 200 includes standard computer components, including random access memory (RAM) 206, at least one processor 208, and external interfaces 210, 212, 214, all interconnected by a bus 216. The external interfaces include universal serial bus (USB) interfaces 210, at least one of which is connected to a keyboard 218 and a pointing device such as a mouse 219, a network interface connector (NIC) 212 which connects the system 200 to a communications network 114, such as the Internet, and a display adapter 214, which is connected to a display device such as an LCD or LED panel display 222.

The system 200 also includes a number of standard software modules 226 to 230, including an operating system 224 such as Linux or Microsoft Windows, web server software 226 such as Apache, available at http://www.apache.org, scripting language support 228 such as PHP, available at http://www.php.net, or Microsoft ASP, and structured query language (SQL) support 230 such as MySQL, available from http://www.mysql.com, which allows data to be stored in and retrieved from an SQL database 232.

Together, the web server 226, scripting language module 228, and SQL module 230 provide the system 200 with the general ability to allow users of the Internet 220 with standard computing devices equipped with standard web browser software to access the system 200 and in particular to provide data to and receive data from the database 232.

However, it will be understood by those skilled in the art that the specific functionality provided by the system 200 to such users is provided by scripts accessible by the web server 226, including the one or more software modules 202 implementing the process 300, and also any other supporting scripts and data 234, including markup language (e.g., HTML, XML) scripts, PHP (or ASP), and/or CGI scripts, image files, style sheets, and the like.

In the SMP system and processes described herein, payment transactions can be performed for the purpose of withdrawing cash from at ATM, or making a purchase at a POS device, with a payment account linked to a card that is registered for mobile payments. The mobile payment is performed via the user device 102, and without requiring the physical payment card. The process of initiating a secure mobile payment with the user device 102 includes the steps of:

generating, at a user device 102, payment card data representing a payment card linked to a payment account of a user, said payment card associated with a card entity 122 and issued by an issuing financial institution;

processing, at the user device 102, the payment card data to generate mobile payment initiation request data requesting mobile payment credentials data for performing a transaction with the payment account;

transmitting the mobile payment initiation request data from the user device 102 to the card entity 122; and

receiving, at the user device 102, the mobile payment credentials data, wherein the transaction can be performed at a payment device 116 when a payment account identifier and a corresponding security code, both of the mobile payment credentials data, are presented to the payment device 116.

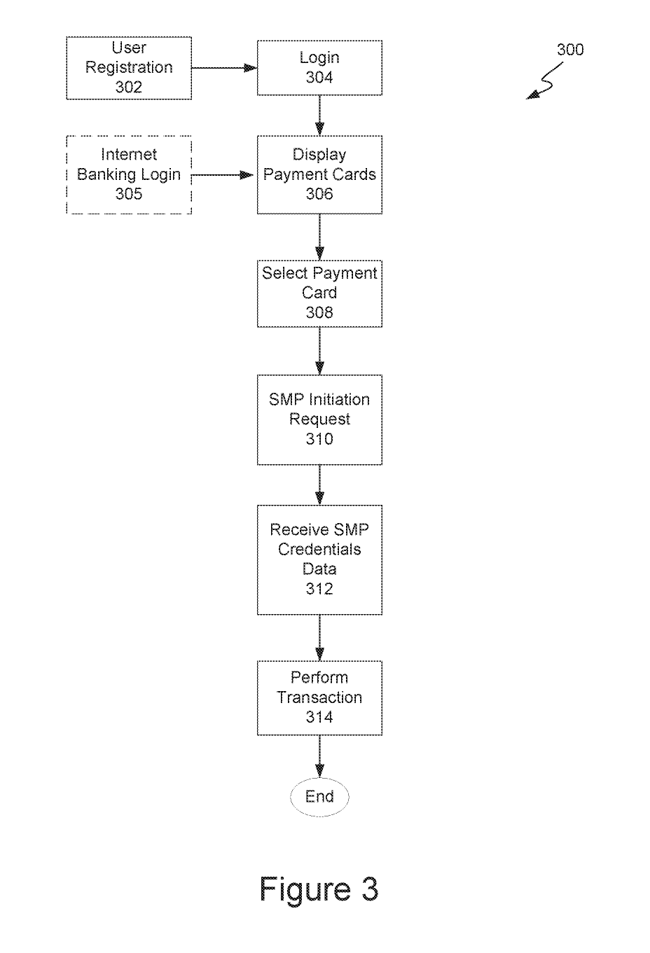

FIG. 3 illustrates the process 300 of performing a SMP transaction with the system 100. The SMP application 104 is loaded onto on the user device 102 via a mobile software distribution platform (such as Google Play Store or Apple Store). Registration of the user 101 with the SMP system occurs at step 302, allowing the user to login with SMP account details provided during registration, at step 304. Once logged in, a list of SMP cards for which secure mobile payments can be performed is presented to the user 101 (at step 206), allowing the user 101 to select a SMP card for which a mobile payment is to be performed (at step 308). At step 310, the user 101 initiates a SMP transaction at step 310 by requesting SMP credentials from the card entity 122. SMP credentials data is received (at step 312) at a mobile device that interfaces with the payment device 116. When a payment account identifier and corresponding security information of the received SMP credentials are entered into the payment device 116, the payment transaction is conducted following standard procedures for using the particular payment device (at step 314).

### User Registration

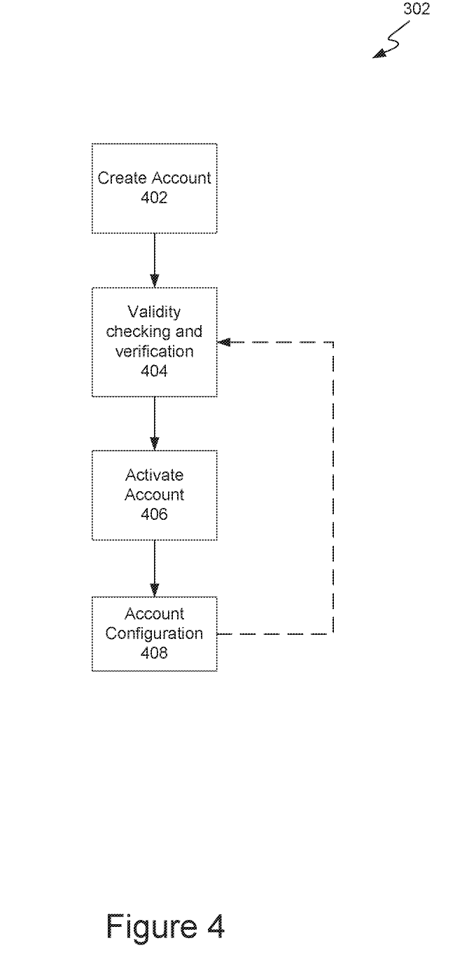

In embodiments where the SMP application 104 is a stand alone application of the card entity 122, the user 101 accesses the SMP system 100 via a user-specific SMP application account obtained by a user registration process. If the user 101 is a new user (i.e. has not previously registered with the SMP system 100), then user registration is performed at step 302. FIG. 4 illustrates the process of user registration to obtain an SMP application account. The registration process can be performed on the user device 102 via the SMP application 104, or by using a generic web browser to access corresponding SMP registration webpages of the card entity 122. To register a new SMP account from the user device 102, the user 101 interacts with the GUI elements rendered on the user device 102 by the UI module 106 and selects to create a new account (at step 402). The user 101 provides user identification details including: their full name, address, mobile telephone number, and email address. In some embodiments, the user 101 is required to also provide details of at least one payment card associated with the card entity 122. The user 101 provides login details including a username and a password for the account which are collectively used by the user 101 to access the SMP system 100 following the completion of the registration process.

At step 404, the account details of the user 101 is transmitted to the card entity 122, where validity checking and verification of the account information is performed. Specifically, the card entity 122 performs cross-checking to ensure that the identity information submitted by the user 101 during the registration process corresponds to that within the customer records of the card entity 122. In some circumstances, verification of the registration information provided by the user 101 involves transmission of the identity information to the issuer 142. In some embodiments, the card entity 122 is configured to record additional information from the user device 102 during account creation at step 402. The additional information can include, for example, the IP address of the user device 102, and one or more hardware identifiers which provide an indication of the identity of the user device 102 based on the hardware components of the device. In such embodiments, the IP address of the registration request and the hardware identifiers of the user device 102 are stored in the SMP server 124, and are used to compare corresponding IP addresses and hardware identifiers obtained from subsequent logins by the user 101 in order to prevent fraudulent access to the user's SMP application account.

At step 406, the user 101 activates their SMP application account with the card entity 122. In the case that the registration information submitted by the user 101 in step 402 is valid, the user 101 receives a registration activation response that provides the user 101 with a visual indication of the validated registration details. In some embodiments, the user 101 is prompted to enter a one time password (OTP) in order to confirm registration with the system. The OTP is generated by the card entity 122 and is transmitted via SMS to the mobile phone number provided by the user 101 during registration. This ensures that the phone number nominated by the user 101 during account registration corresponds to a device (i.e. a smartphone) which the user 101 has access to for the purpose of performing a mobile payment. The card entity 122 can be configured to perform verification of particular registration information provided by the user 101 with the issuer 142. At step 408, the user 101 confirms the registration of their identification details by transmitting the OTP to the card entity 122. In other embodiments, the transmission of the OTP may occur over the Internet via entry of the OTP into a form provided by the IBS of the issuer 142.

If the registration information provided by the user 101 is determined to be valid by the card entity 122, then a new SMP account is registered by the storage of the user 101 identification details in the SMP server 124. Specifically, the username, password and payment card information are stored within the non-volatile storage components 204 of the SMP server 124 in encrypted form. A hashing function, such as SHA-1, is applied to the plaintext of the password to produce a ciphertext, which is subsequently stored as described above, in order to protect against the exposure of the account in the event of a security breach at the card entity 122 devices.

### Account Configuration

Following successful activation of their SMP application account, the user 101 can perform account configuration at step 408. In the described embodiments, account configuration allows the user 101 to add, modify and/or remove information associated with their SMP application account, including user identity information, contact information and SMP operational information. The user identity information that can be configured includes the user's name, address, mobile telephone number, email address, and other personal identification information provided to the SMP system 100 by the user 101 during account creation (i.e. at step 402). For example, the user 101 can perform account configuration in order to change the contact mobile telephone number recorded by the card entity 122 in association with their corresponding SMP application account.

In response to a request to modify user identity and contact information recorded for a particular SMP application account, the SMP system 100 may conduct verification and validation of the new user identity and contact information in accordance with the process of step 404 as described above. In some embodiments, the system 100 is configured to prompt the user 101 to re-activate their account (as described at step 406) when particular identity and/or contact information is modified during account configuration. For example, modification of the mobile telephone number recorded for a SMP application account may trigger the card entity 122 to prompt the user 101 to reactivate their account using an OTP provided to this new number.

The account configuration process of step 408 allows the user 101 to modify information related to the operation of the SMP system 100 with respect to how mobile payments can be performed with a particular registered payment card. The SMP operational information that can be modified by the user 101 during the configuration process of step 408 includes SMP parameter data representing the parameters that are to be used by the card entity 122 to generate SMP credentials in response to requests to initiate mobile payments with a selected payment card. The user 101 can configure the values of each parameter for each specific payment card, including: i) the expiration time period indicating a length of time for which generated SMP credentials will be valid; ii) the transaction number limit representing the maximum number of transactions that can be performed using the generated credentials; and iii) the transaction amount limit value, indicating the maximum value of a transaction performed with using the credentials. The user 101 can save a new value for any one or more of the SMP parameters during configuration, and these saved values are used by the card entity 122 to generate SMP credentials in response to a SMP initiation request (as discussed herein below).

Default values for each SMP parameter are assigned for a payment card by the card entity 122 during registration. The system 100 may enforce restrictions on the values that can be assigned to each SMP parameter. For example, the expiration time period parameter value may have an upper bound defined by a maximum expiration time period value. In the described embodiments, the maximum expiration time period value is set to 5 minutes, such that any SMP credentials produced by the card entity 122 will expire no longer than 5 minutes after their generation. This is to prevent use of the SMP credentials by an unauthorised party (for example, where the user disengages from the payment process after providing the credentials to the payment device, as discussed below).

### User Login

Following the registration of an account with the SMP system 100, the user 101 accesses the SMP system by a login process, at step 304. The user 101 selects a “login” option on the GUI display rendered by the UI module 106 executing on the user device 102, and is presented with a login form requesting the details of the user 101, as determined during the registration process of step 302. The user provides, at least, the username and password corresponding to their registered SMP account and submits a login request to the card entity 122. The login request is processed by the SMP server 124, which performs validation of the username and password by searching for the provided username among the usernames of one or more other registered users of the system 100. If a match is found, hashing is applied to the provided password and a comparison is performed between the resulting ciphertext and that of the registered user with the corresponding username. If the ciphertexts of the passwords match, then the login is successful, and a login success response is transmitted from the card entity 122 to the user device 102. Otherwise, the login attempt is rejected and the user 101 is prompted with an option to enter alternative login details.

In embodiments where the SMP application 104 is a generic web browser, the user 101 can access the SMP system 100 by logging into the Internet Banking Service (IBS) of the issuer 142 (at step 305). The user 101 navigates the web browser application 104 to the relevant login page for the issuer 142 IBS and chooses the appropriate “login” option on the GUI display, allowing the user 101 to enter their customer ID and passcode combination (e.g. a PAN and PIN combination) to access the banking service. The login request is processed by the issuer 142, which involves comparing the customer ID provided by the user 101 to information stored on the customer database of the issuer 142. If a match is found, hashing is applied to the provided password and a comparison is performed between the resulting ciphertext and that of the registered user with the corresponding username. If the ciphertexts of the passwords match, then the login is successful, and a login success response is transmitted from the issuer 142 to the user device 102. Otherwise, the login attempt is rejected and the user 101 is prompted with an option to enter alternative login details.

A successful login to the IBS of the issuer 142 allows the user 101 to access a “secure mobile payment” option within the IBS. In the described embodiments, the issuer 142 IBS provides a direct interface (referred to as an “IBS SMP Interface”) to the SMP functionality of the card entity 122 (as otherwise provided by the SMP application 104). The IBS SMP interface allows the user 101 to perform SMP with any arbitrary payment card issued to the user 101 by the issuer 142, provided that the payment card is associated with a card entity 122 that implements the SMP system and process described herein.

The IBS SMP interface displays a list of SMP cards to the user 101, allowing the user 101 to: select a particular payment card for which a mobile payment is to be initiated (as described below); and/or perform configuration to modify information related to the operation of the SMP system 100 with respect to how mobile payments can be performed with the particular selected payment card. The user 101 can use the IBS SMP interface to modify the SMP parameter data for the card, in accordance with the process described above (at step 408).

In other embodiments, the SMP application 104 is an internet banking application of the issuer 142 configured to provide customers of the issuer 142 with access to respective internet banking services. In such embodiments, the SMP system 100 is configured to allow the user 101 to perform mobile payments by accessing the IBS SMP interface through the internet banking application 104.

### Displaying the Mobile Payment Cards

When logged into the SMP system 100, either by the login process of step 304 described above, or by a login to the Internet Banking Service (IBS) of the issuer 142 (at step 305), the user 101 is presented with a list of one or more mobile payment cards of the user 101, which are the payment cards on which the user 101 is able to perform a secure mobile payment (referred to as “SMP cards”). A secure mobile payment will be initiated based on a payment card selected from the SMP card list, such that a payment is made from the payment account associated with the selected payment card, using SMP credentials generated by the card entity 122 (as described below).

The process of selecting a payment card from the available SMP cards of the user includes: i) transmitting, to the card entity 122, a request for mobile payment card data; ii) receiving a mobile payment card list data from the card entity 122 that indicates the set of payment cards of the user for which mobile payments can be performed; and iii) displaying, on the user device 102, the mobile payment card list data.

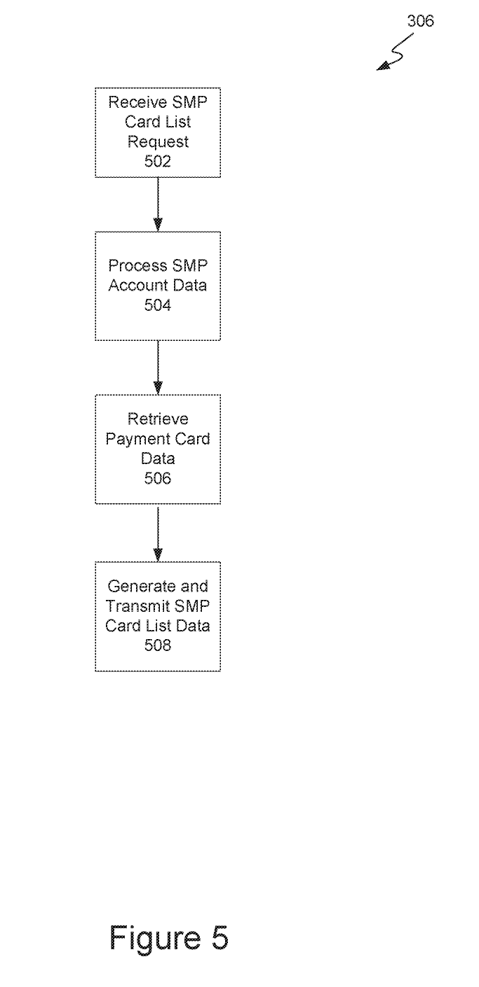

FIG. 5 illustrates the process by which the SMP card list data is generated by the card entity 122 for the user 101. At step 502, the card entity 122 receives a request for secure mobile payment card data as transmitted from the SMP application 104 executing on the user device 102. The request for the SMP card data includes user identification data that provides an indication of the identity of the user 101. In the described embodiments, the user identification data includes information of the user's corresponding SMP application account, such as the user's name, address, telephone number, email, and/or SMP application account username (as provided during registration). At step 504, the SMP server 124 processes the SMP application account information of the SMP card data request, and (at step 506) generates payment card data for the payment cards of the user 101 that are associated with the card entity 122, and for which mobile payments can be performed. The SMP application 104 can be configured to enable adding of payment cards from the card entity 122. For example, the SMP application 104 can generate a first QR code for a specific card selected by the user using the SMP application 104. The SMP application 104 then presents the first QR code to enable a transaction to be carried out, whereby OTP authentication can be optional.

The mobile payment card data generated includes, for each payment card: the card number; an indication of the issuing financial institution; and the card ICA value of the payment card. At step 508, the SMP server 124 generates SMP card list data representing the payment card data of each of the SMP cards for user 101, and transmits the SMP card list data to the user device 102 in a predetermined form (such as, for example, within a SMP card list message).

The SMP card list data is transmitted from the card entity 122 to the user device 102 in encrypted form and on request by the SMP application 104. The logic module 110 determines the frequency with which the SMP card list requests are sent to the card entity 122. In the described embodiments, a SMP card list request is transmitted when the user 101 opts to select a payment card in order to ensure that the payment cards presented to the user 101 accurately reflect all the payment cards which are registered to the SMP application account of the user 101 at that particular time.

In other embodiments, the logic module 110 may schedule periodic updates of the SMP card list at various times when the user 101 is using the SMP application 104. The logic module 110 directs the transfer of the SMP card list from the communication module 106 to the card management module 112. The card management module 112 decrypts the SMP card list data and directs the UI 106 to display, for each corresponding payment card, payment card data representing the payment card and the associated payment account of the card owner.

### Selecting a Payment Card

At step 308, the user 101 selects a payment card from the set of one or more SMP cards displayed on the user device 102. The user 101 interacts with GUI elements displayed on the user device 102 to begin the card selection process. A list of the SMP cards is obtained from the SMP server 124 of the card entity 122 by the communications module 106, as described above. In the described embodiments, the details of each payment card are displayed to the user 101, including the card number, the issuer 142 of the card, and the corresponding card owner. The user 101 operates the user device 102 to select a payment card to be used for making the payment transaction. The selection results in the payment card data of the selected payment card (the “selected payment card data”) being transmitted to the logic module 110 by the card management module 112. In the described embodiments, the payment card data includes an indication of one or more of: the card number; the card entity 122; and identification information of the user.

In embodiments where the SMP application 104 is a generic web browser configured to access the IBS SMP interface of the issuer 142, the SMP cards are presented to the user 101 via a list that is graphically displayed on the interface. The SMP card list is dynamically updated by the issuer 142 based on the eligibility of each particular payment card to be used for mobile payment transactions. Eligibility can be influenced by factors such as: the card product type (e.g. debit vs credit card); the activation status of the card (i.e. whether the card has been activated or is awaiting activation); and whether the card entity associated with the card implements the SMP system 100. The issuer 142 can allow the card entity to regulate the SMP card list.

### SMP Initiation Requests

Prior to performing a secure mobile payment transaction at a payment device, the SMP application 104 processes the selected payment card data to generate a secure mobile payment (SMP) initiation request. The SMP initiation request allows the card entity 122 to enable the selected payment card to be transacted through a mobile payment process by generating secure mobile payment credentials according to the processes described herein. The SMP initiation request data is generated by the logic module 110 based, at least, on: the selected payment card data; mobile payment parameter data indicating the parameters of the mobile payment credentials; and identification data identifying the user.

In the described embodiments, the parameters of the mobile payment credentials include: i) an expiration time period indicating a length of time for which the mobile payment credentials are valid for performing transactions; ii) a maximum transaction number value indicating the maximum number of transactions that can be performed on the payment account using the mobile payment credentials; and iii) a maximum transaction amount value, indicating the maximum value of a transaction that can be performed with the payment account using the mobile payment credentials.

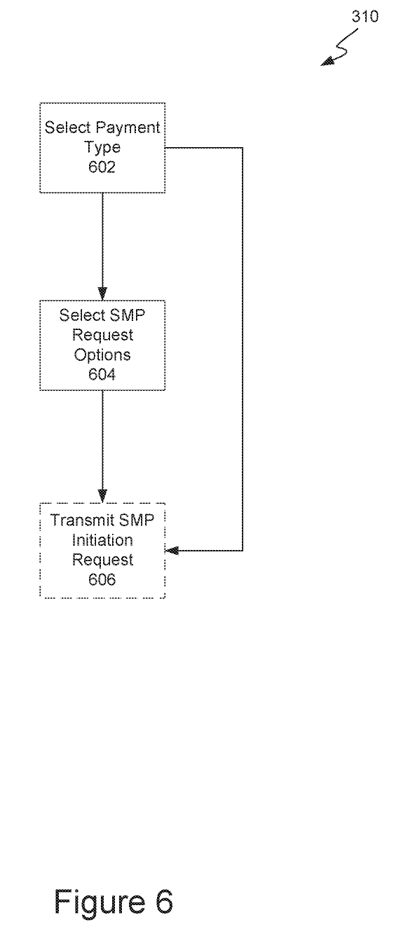

FIG. 6 illustrates the process of generating the mobile payment parameter data for the SMP initiation request. At step 602, the user 101 selects a type of the secure mobile payment that is desired to be performed with the selected payment card. In the described embodiments, the payment type can be a “quick payment” indicating that the card entity 122 should use the presently saved values of the secure mobile payment (SMP) parameters to produce the mobile payment credentials. The saved values of the SMP parameters for each SMP card of the user 101 are maintained by the SMP server 124, and can be default values (as assigned to the particular SMP card by the card entity 122), or other values as configured by the user 101 in the account configuration process described above (step 408).

Alternatively, the payment type can be a “custom payment” type which allows the user 101 to choose particular values of the SMP parameters to include within the SMP initiation request data. That is, by using the “custom” payment type, the user 101 can (at step 604) customise the limitations of the mobile payments that can be performed with SMP credentials generated in response to the SMP initiation request. For example, a user 101 may wish to perform mobile payments on a payment card that has saved SMP parameter values of: a $100 max transaction amount; a maximum of one transaction per generated SMP credentials; and an expiry of 2 minutes for the generated SMP credentials. However, the mobile payments desired by the user 101 may involve two transactions, each with a value of $150, and potentially occurring more than 2 minutes apart in real-time.

Selecting a custom payment type for the SMP initiation request (at step 602) allows the user 101 to request, from the card entity 122, SMP credentials that allow mobile payments to be performed according to parameters that are specified by the user 101 at the time of the request, and without modifying the saved parameter values for the particular selected payment card. The SMP application 104 presents the user 101 with graphical SMP option elements, via the UI 106, through which the user 101 can specify the parameters for the SMP initiation request. The SMP option elements can be configured to show the presently saved SMP parameter values for the selected payment card, and any maximum allowed value for each parameter, such that the user 101 can choose whether or not to modify the saved values prior to completing the SMP initiation request (at step 604).

The SMP initiation request data also includes user identification data which identifies the user 101 to the card entity 122. In the described embodiments, the user identification data is in the form of the login username and password of the SMP account of the user 101. In other embodiments, the user identification information can include additional identification information, in the form of one or more of: the full name, address, telephone number and/or email address of the user 101; and the card number, expiry date, CVV code and/or PIN of the selected payment card.

The system 100 may prompt the user 101 to enter additional user identification information (such as the PIN of the selected card) in response to the setting of a particular SMP parameter value during the initiation request. For example, in some embodiments of the system, if the user 101 requests a custom payment with the transaction amount limit parameter value exceeding the presently saved value for the selected payment card, then the SMP application 104 can request that the user 101 enter the PIN of the selected payment card into a form displayed on the UI 106.

The selected payment card data, mobile payment parameter data, and user identification data is encapsulated into an SMP initiation request by the logic module 110. The logic module 110 generates the SMP initiation request data in a predetermined form (such as, for example, a SMP initiation request message known by the card entity 122) and the data is transmitted to the card entity 122 via the communications module 108.

### SMP Initiation Request Processing by the Card Entity

The card entity 122 of the SMP system 100 is configured to enable payments to be made from a payment card via a mobile computing device by performing the steps of:

receiving, at a card entity device, mobile payment initiation request data requesting mobile payment credentials data for performing a transaction with a payment account of a user 101, said payment account linked to a payment card associated with a card entity 122 and issued by an issuing financial institution;

processing, at the card entity device, the received mobile payment initiation request data to generate mobile payment credentials data for performing a transaction with the payment account; and

transmitting, from the card entity device, the mobile payment credentials data to a user device 102, such that the payment can be performed at a payment device when a payment account identifier and a corresponding security code, both of the mobile payment credentials data, are presented to the payment device.

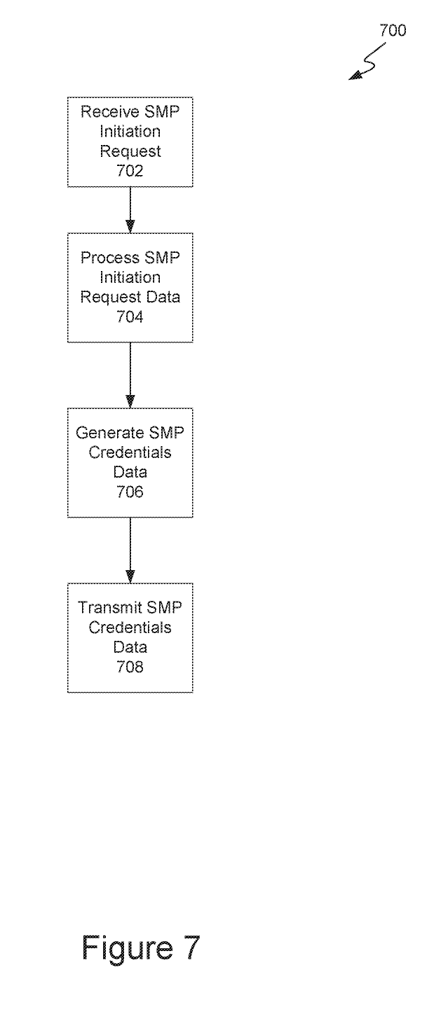

FIG. 7 illustrates the processing of the SMP initiation request message by the card entity 122. At step 702, the SMP initiation request data is received by the SMP server 124. The SMP server 124, at step 704, extracts and processes the user identification data to verify the authenticity of the SMP initiation request. In the described embodiments, the verification process involves extracting the SMP account username and password combination, and performing a search on the registered SMP account data of the SMP server 124 to find a matching username and password combination. If no match is found between the supplied username and password and a corresponding combination as registered with the SMP server 124, then the SMP initiation request is invalid, and a request failure notification is transmitted to the SMP application 104 in a pre-determined form.

Otherwise, the verification process involves performing a check to ensure that the selected payment card data of the SMP initiation request matches to the payment card data of a registration key for the user's matching SMP application account. The associated SMP card list data structure of the matching account is extracted, and a search is performed for a registration key containing payment card data which matches to the selected payment card data of the SMP initiation request. If no registered key contains payment card data matching to the selected payment card data then a failure notification is transmitted to the SMP application 104, as described above.

In some embodiments, the verification of the SMP initiation request involves processing additional information included within the user identification data. For example, if the payment type is a “custom” payment and where the initiation request contains additional verification information of the user 101 (e.g. the PIN of the card), then the SMP server 124 can be configured to perform verification of the additional information by sending card verification request data to the issuer 142 of the selected payment card. The card verification request data is transmitted in a predetermined form, and results in the issuer 142 providing corresponding card verification response data to the card entity 122. If the card verification response data indicates that the additional information (e.g. the card PIN) is incorrect, then a failure message is transmitted to the SMP application 104, as described above.

### Creating the Account Identifier and Security Code Token Pair

Following the processing of the user identification data, the card entity 122 generates SMP credentials that enable a secure mobile payment to be performed on the selected payment card via the user device 102, and in accordance with the received SMP initiation request. At step 706, the SMP initiation request is processed by the SMP server 124 to generate SMP credentials data, including: i) a payment account identifier representing the information needed to complete a transaction with the payment account for which the payment is authorised; and ii) a security code corresponding to the payment account identifier, in accordance with the processes described below.

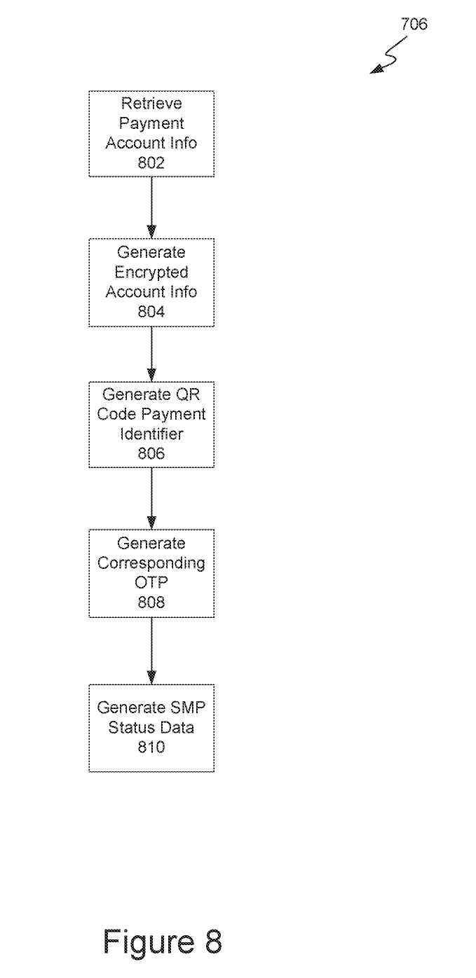

FIG. 8 illustrates the process by which SMP credentials data is generated by the card entity 122 in response to receiving SMP initiation request data. At step 802, payment account data representing information of the payment account corresponding to the selected payment card is retrieved by the card entity 122. In the described embodiments, the payment account data is obtained from the issuer 142 on request by the card entity 122. For instance, the card entity 122 can collaborate with the issuer 142 such that the payment account data is obtainable by the card entity 122. In alternative embodiments, the payment account data is stored within the SMP server 124, such as within the list of SMP cards associated with the user 101.

The payment account data reflects a set of variables that are typically encoded in tracks one and two of a standard financial magnetic stripe card (such as an ATM card) according to the ISO/IEC 7813 protocol. This information includes: the account owner name; the primary account number (PAN); the expiration date of the card; a service code; and a discretionary data value, such as a PIN verification key indicator, a PIN verification value, a card verification value (CVV) or a card verification code (CVC). At step 804, encryption is applied to the payment account information using a symmetric key encryption algorithm, where the key is known by both the card entity 122 and the payment device 116 for which the transaction is performed on (as described below).

At step 806, a payment account identifier is generated in the form of a machine-readable optical label containing the encrypted account information. In the described embodiments, the payment account identifier is a second QR code that is dynamically generated by the SMP server 124 according to the ISO/IEC 18004:2015 standard. Encoding of the account information proceeds with using version 10 in binary mode, where 8 bits used to encode each character in accordance with ISO 8859-1. In the described embodiments, the code error correction level is set to high (‘H’) allowing restoration of approximately 30% of the encoded codewords via Reed-Solomon error correction. This supports the encoding of up to 174 characters representing the encrypted payment account information, rendered in a 57×57 module format.

Other embodiments of the system and process may utilise different encoding techniques for the generation of the second QR code identifier. Specifically, the version and mode of the encoding scheme can be configured based on the amount of data produced by the encryption process. For example, version 40 binary encoding allows for a larger number (i.e. 1264) of ASCII text characters to be encoded, which may be beneficial when account information encryption is performed using a technique which produces long ciphertext representations (such as asymmetric encryption with large key sizes). For the same level of code error correction, this results in payment account identifiers of a larger data size and may therefore require increased bandwidth for transmission to the user device 102. In other embodiments, the encoded payment account information may be supplemented with redundant information which serves to visually indicate to the user that the code represents a payment card (such as the display of the name of the card association entity and/or card owner).

In embodiments where a particular QR code and corresponding security code remain valid for only a single transaction, the operation of the system 100 involves generating a different QR code based identifier for each unique mobile payment transaction performed, even where the payment account information (i.e. the selected payment card) remains the same. This is achieved by including a credentials request identifier in the data encoded within the QR code which uniquely distinguishes between particular SMP initiation requests received by the card entity 122. The credentials request identifier is maintained by the SMP server 124 and, in the described embodiments, is an integer that is incremented each time a SMP initiation request is performed by a user of the SMP system 100. The QR code is only valid for a pre-determined duration, which is equal to the expiry time specified by the associated SMP parameter value.

At step 808, the card entity 122 generates a security code in the form of an OTP based on the payment account information. In the described embodiments, the OTP is a 4-digit number generated by using an OTP generation key to encrypt the account PAN value in combination with a seed value which changes dynamically but predictably (such as, for example, the number of 30 second periods having elapsed since a particular reference time). This ensures that such there is no relationship between the generated OTP for the authorised payment and the actual PIN value of the payment card on which the payment is to be made. The card entity 122 generates a new OTP for the selected payment card, and stores this value within a “SMP token vault” data structure residing on the SMP server 124.

At step 810, the card entity 122 generates SMP status data for the SMP credentials. In the described embodiments, the SMP status data is a collection of variables which store information in relation to the parameters of the SMP credentials, including: the number of transactions successfully performed with the SMP credentials, the maximum number of transactions that may be successfully performed with the SMP credentials, the maximum value of a transaction that is permitted to be performed using the SMP credentials, and the expiry date and time of the SMP credentials. The SMP status data values are initialised based on the SMP initiation request data. The SMP status data is stored in the SMP server 124, and is linked to the corresponding entry of the SMP token vault data structure that contains the SMP credentials.

During requests to authenticate a mobile payment transaction at an ATM or POS device (as described below), the ATM or POS payment device can be configured to validate the OTP code using a specialised hardware device. For example, a payment device (such as an ATM) can be configured to use a hardware security module (HSM) to store the OTP generation key and the seed value, and to perform the encryption process. PC based payment devices (such as POS stations) can be configured to utilise one or more of the associated computing devices 200 for the purpose of performing code validation, either within a software application or a dedicate hardware cryptoprocessor, such as a trusted platform module (TPM). The TPM can be configured to validate the OTP code, as an alternative to, or additionally with, other hardware devices, such as a database 232 or other local storage devices. Alternatively, the ATM or POS payment device 108 can be configured to request remote validation of the OTP code from the card entity's SMP server 124, as described below. Generally, during a transaction, the OTP code is validated, then the OTP code is transmitted to an appropriate acquiring channel and subsequently, the OTP code is associated with acquiring information like a QR code.

A third QR identifier and corresponding OTP security code together form a “token pair” which functions to prevent the exposure of account information when a SMP transaction is conducted, and thus reduces the likelihood of the user's payment account data being stolen and subsequently used for fraudulent purposes. That is, the combination of the third QR and OTP codes encapsulate the account PAN and security PIN during the exchanges between the card entity 122 and the user device 102 that enable a secure mobile payment to be performed, while maintaining compatibility with the existing processes for handling financial transactions at the back-end (i.e. between the issuer 142 and the card entity 122). Additionally, since the third QR identifier and OTP code are domain specific (i.e. they are uniquely created for the purpose of using the SMP system 100) the user's underlying payment account, and any other tokens associated with this account, are protected in situations where the identifier and code are compromised.

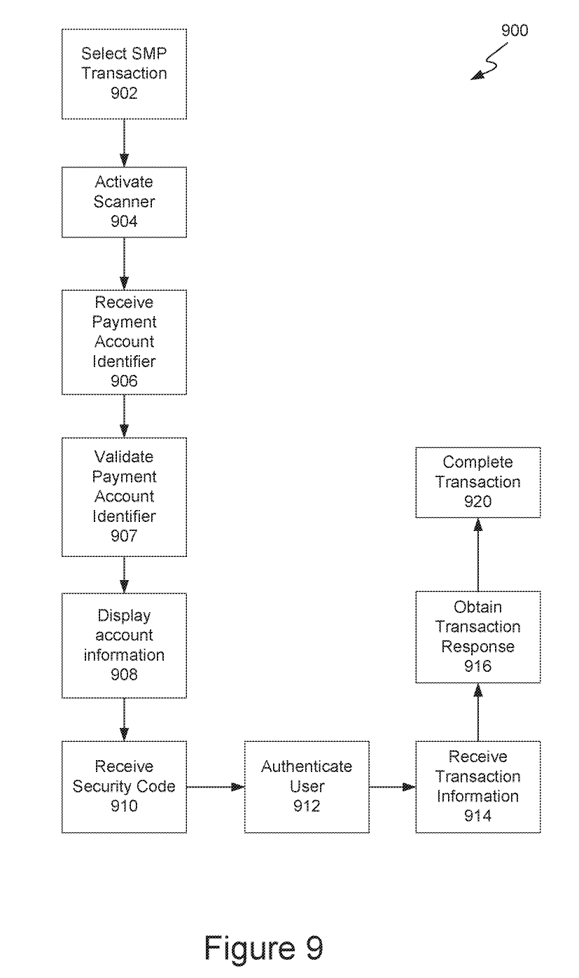

In alternative embodiments, the SMP system 100 can be configured to allow the use of the user's real payment card PIN as the security code for a transaction performed with that particular card. The user can permit the secure mobile payment transaction to be performed at a payment device using their PIN value as the security code by setting an appropriate option during the SMP initiation request process of step 604 (see FIG. 6). In this case, during processing of the SMP initiation request (i.e. at step 704) a representation of the card PIN value is transmitted from the issuer 142 to the card entity 122, allowing the SMP server 124 to store the PIN representation for the selected payment card within the SMP token vault data structure. The PIN value representation is stored in addition to any existing OTP code generated for the selected payment card in respect of the payment request. During authentication (i.e. at step 912 of FIG. 9 described below), the user 101 can elect to enter either the generated OTP or the user's actual PIN code as the security code, for the purpose of achieving authentication to perform a payment transaction with the payment account. Generally, the OTP authentication is most desirable as different cards have different PIN values. The PIN values can be mapped/associated using known methods.

In the described embodiments, the third QR code payment identifier and the OTP security code are set to expire a predetermined period of time (such as, for example, 5 minutes) after generation. The expiry time is stored as a variable in the SMP status data (as described above), and is calculated on the generation of the third QR code and security code by the addition of the specified expiry period to the value of the present data and time. On expiry the identifier and code become unusable for the purpose of performing a payment transaction. The payment account identifier and security code token pair data are stored in the SMP server 124 within the SMP token vault data structure, with a link to the corresponding SMP status data for which the token pair is generated (i.e. the payment card, payment parameter information, and user identification information as described above). The SMP credentials data (i.e. the token pair) and the corresponding status data are removed from the SMP server 124 on expiry, or when the number of successfully completed payment transactions reaches the value of the maximum number of transactions, as recorded within the SMP status data, whichever occurs earliest.

At step 708, the SMP credentials data is transmitted to the user device 102 by the card entity 122, such that the mobile payment can be performed at the payment device 116 when the payment account identifier and the security code are presented to the payment device 116.

With reference to FIG. 3, at step 312 the SMP credentials are received at the user device 102 which executes the SMP application 104. The communication module 108 of the SMP application 104 receives the SMP credentials data from the card entity 122. The logic module 110 processes the SMP credentials data, and directs the UI module 106 to display a corresponding SMP credentials notification to the user 101 via the user device 102 GUI elements. The user 101 is able to direct the SMP application 104 to selectively display the third QR code based payment identifier and/or the security code onto the display 222 of the user device 102 for the purpose of performing a payment transaction, at step 312. For example, the SMP application 104 can be configured to display the third QR code separately to the OTP code, such that the third QR code can be viewed and scanned by another individual (such as a cashier) without compromising the security of the transaction.

In other embodiments, the SMP credentials notification may be in a predetermined form that is interpretable by the user device 102 irrespective of whether an instance of the SMP application 104 is executing on that device. For example, the SMP credentials notification may be in the form of an SMS text message with the generated third QR code and corresponding OTP embedded as content elements within the message. Alternatively, the SMP credentials notification may contain a link or reference (such as, for example, a web URL) to the generated third QR code and corresponding OTP for the user to access.

### Conducting a Payment at a Payment Device

The described embodiments of the SMP system and process allow the user 101 to make a payment with a payment card that is registered or eligible for performing mobile payments in the form of an ATM withdrawal or POS purchase transaction. The user 101 interacts with a payment device 116 for the purpose of completing the payment, where the payment device 116 is an ATM device or a POS device (such as a PC terminal configured to execute a POS software application) according to the respective type of payment transaction performed by the user 101.

The SMP system 100 is configured to perform a mobile card payment transaction at a payment device 116 by a process that includes the steps of:

receiving, at the payment device 116:
i) transaction information data representing a payment transaction requested in respect of a payment account of a user 101, said payment account associated with a payment card; and
ii) payment credentials data, representing a payment account identifier of the payment account and a corresponding security code;

processing, at the payment device 116, the payment credentials data to generate authentication data indicating whether the transaction is permitted on the payment account;

transmitting, if the transaction is permitted on the payment account, the payment credentials data and the transaction information data from the payment device to a card entity device of a card entity 122 linked to the payment card, said card entity 122 configured to provide response data by processing the payment credentials data and the transaction information data according to any one of the processes described herein; and

processing, at the payment device 116, the response data received from the card entity 122 to complete the transaction.

In the described embodiments, the payment credentials data includes a payment account identifier representing the information needed to complete a transaction with the payment account of a selected payment card, and a security code corresponding to the payment account identifier. With reference to FIG. 3, at step 314, the third QR code payment account identifier and corresponding security code are used by the user 101 to complete the payment transaction at the payment device 116. FIG. 9 illustrates the process by which a payment transaction is made from a payment device 116 in accordance with the described SMP system 100. At step 902 the user 101 initiate a mobile payment transaction on the terminal 120 of the payment device 116. For example, in embodiments where the payment device 116 is an ATM, the user 101 interacts with an input device of the terminal 120 (such as a touchpad, keypad, screen, or other peripheral) to select the SMP functionality mode of operation. Similarly, in embodiments where the payment device 116 is a POS device the SMP transaction mode is initiated at the terminal 120 by the merchant or other delegated person (such as a cashier, for example).

At step 904, the payment device 116 activates a reader 118 configured to read a payment account identifier displayed by the user device 102. In described embodiments, the reader 118 is a QR code scanner configured to interpret a QR code account identifier displayed on the user device 102. For example, the reader 118 of an ATM device 116 may be a NCR SS22e 2D barcode scanning module configured to read QR codes of the particular version and data mode used by the SMP server 124 as described above. At a POS payment device, the reader 118 may be a conventional 2D POS barcode scanner such as a laser scanner, a CCD scanner, or a camera based scanner. The reader 118 is locally connected to the terminal 120 of the ATM or POS device 116. The scanned image data produced by the reader 118 is transmitted to the terminal 120 via an application specific communications interface, such as for example the RS-232 serial interface, or other proprietary interfaces used in POS and/or ATM systems.

The reader 118 of the payment device 116 receives a fourth QR code payment account identifier from the user 101, at step 906. The reader 118 scans the fourth QR code and transmits the scanned fourth QR code data to the terminal 120. The terminal 120 is configured to validate the scanned fourth QR code data, at step 908, to ensure that the fourth QR code represents valid financial payment account information. In the described embodiments this includes performing the decryption steps necessary to recover the card payment account details from the ciphertext encapsulated within the fourth QR code (as described above).

At step 908, the payment device 116 displays the financial payment account information details on the terminal 120 of the device 116. In some embodiments, the payment device 116 is also configured to display details of the card owner. For example, the ATM screen or POS PC monitor of the terminal 120 may be configured to display the PAN, card owner name and issuer organisation name to the user 101. The user 101 confirms the payment card and/or card owner information by operating the terminal 120. At step 910, the user 101 is prompted to enter the security code corresponding to the payment identifier. In accordance with the processes described hereinabove, the security code entered by the user 101 may be in the form of an OTP or the PIN of the payment card.

At step 912, the payment device 116 is configured to process the payment account information and the OTP code to generate authentication data indicating whether the mobile payment transaction is permitted for the payment account. Specifically, the authentication process determines whether the user 101 can perform a SMP transaction with the payment account represented by the fourth QR code identifier, based on the provided security code. In the described embodiments, the payment device 116 can be configured to perform the authentication process locally using a HSM which stores the OTP generation key and the seed value used by the SMP server 124 to generate the OTP code. The HSM encrypts the PAN extracted from the fourth QR code data with the OTP generation key and seed value to produce a candidate OTP code, which is compared to the OTP provided by the user 101. If the candidate and provided OTP codes match, then the mobile payment transaction is authenticated.

Alternatively, the payment device 116 can be configured to request authentication of the token pair by the SMP server 124. The extracted PAN and presented OTP values are securely transmitted to the card entity 122 via a local network (such as in the case of an ATM payment device) or a wider area communications network 114 (such as for a merchant POS terminal). Specifically, data is transmitted from the payment device 116 to the card entity 122 using the NCR Direct Connection (NDC) communication protocol. The SMP server 124 performs a lookup operation on the SMP token vault data structure to determine whether the PAN and OTP provided to the payment device match the corresponding stored values. The SMP server 124 returns a positive authentication response indicating that the user 101 is authenticated to transact the account. Otherwise, the user 101 is not authenticated and a negative response is returned to the payment device terminal 120.

If the user 101 is authenticated to transact the payment account, at step 914 the terminal 120 prompts the user 101 to enter transaction information relating to the payment that is to be made. The transaction information includes the amount of the withdrawal or POS purchase depending on the type of payment.

At step 916, the payment device 116 transmits the payment authorisation data and the transaction information to the card entity 122. The process for conducting a mobile payment transaction made on a payment card includes the steps of:

receiving, at a card entity device, from a payment device 116:
i) transaction information data representing a payment transaction requested in respect of a payment account of a user 101, said payment account associated with the payment card; and
ii) payment credentials data representing a payment account identifier of the payment account and a corresponding security code;

processing, at the card entity device, the payment credentials data and the transaction information data to produce validity data indicating whether the payment transaction specified by the transaction information data can be validly performed, the validity data based on an indication of the prior authorisation of the transaction with the payment account;
generating, at the card entity device, if the payment transaction is valid, financial transaction data representing a standard financial transaction message for conducting the payment transaction;
transmitting, from the card entity device, the standard financial transaction message to the issuing financial institution for processing, and receiving corresponding response data indicating the success or failure of the payment transaction; and

transmitting the response data from the card entity device to the payment device to allow completion of the payment transaction.

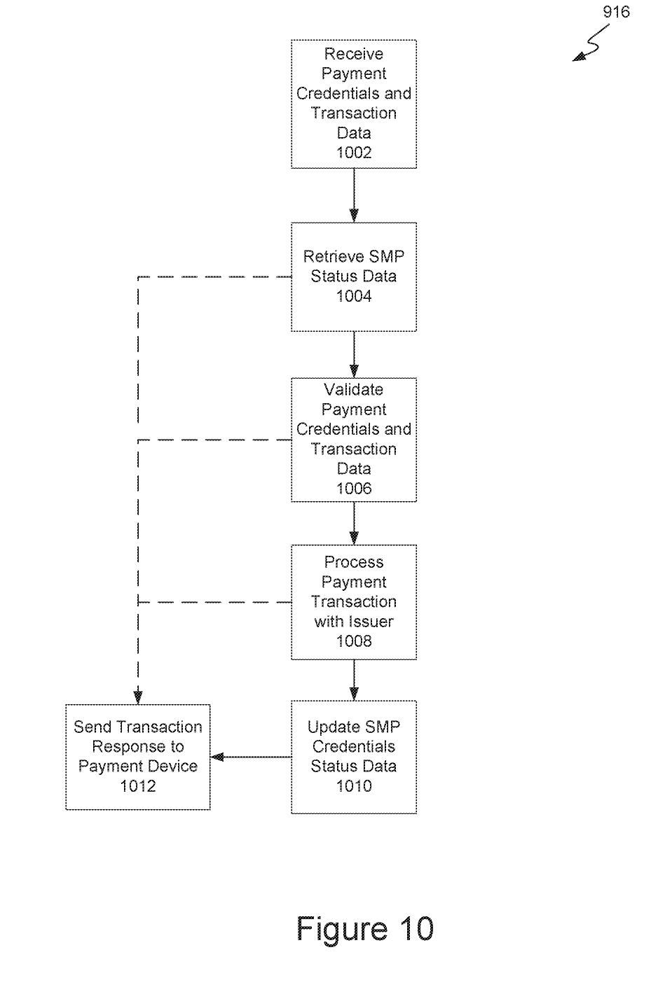

As shown in FIG. 10, following the reception of the payment credentials and transaction data from the payment device 116 (at step 1002), the card entity 122 processes the payment account identifier and security code token pair of the received payment credentials, and searches the SMP token vault to retrieve matching SMP credentials (i.e. the stored fourth QR code identifier and security code) and corresponding SMP status data (at step 1004). If matching SMP credentials cannot be found for the received payment credentials, then the transaction is not permitted to be performed on the identified payment account, and a transaction response indicating the failure of the transaction is transmitted to the payment device (at step 1012).

The transaction data received from the payment device 116 is verified in respect of the corresponding status data retrieved by the SMP server 124 (at step 1008). In described embodiments, the SMP server 124 checks that the payment amount specified in the transaction data is less than or equal to the maximum transaction value limit specified by the SMP status data. If this maximum transaction value check is satisfied, the SMP server 124 processes the SMP status data to determine whether the transaction counter value is less than the corresponding value of the maximum number of transactions. If so, then the SMP server 124 determines whether the payment transaction is valid based on the expiry period of the matching SMP credentials. The payment transaction is valid if the transaction date and time value of the transaction data is less than the expiry date and time as specified by the SMP status data.

If the payment transaction satisfies the aforementioned checks then, at step 1008, the SMP server 124 transmits the payment card information, card owner information, and transaction information to the transaction server 126 which executes the financial transaction. The transaction server 126 is configured to generate data representing a standard financial transaction according to the ISO 8583 message protocol, and this ISO 8583 transaction data is transmitted to the issuer 142 for processing. Transaction processing proceeds according to the conventional steps for executing and ISO 8583 financial transaction request. At step 1010, if the transaction is successfully approved (as described below), then the SMP server 124 updates the SMP status data for the SMP credentials by incrementing the transaction counter value.

The transaction server 126 receives issuer response data from the issuer 142 in respect of the request to perform the ISO 8583 transaction. If successful, the card entity 122 records the completion of the SMP transaction in the SMP server 124. In some embodiments, post transaction processing updates are performed in order to remove the SMP credentials and corresponding status data if: the transaction counter value has reached the maximum number of transactions for the SMP credentials; and/or the present date and time exceeds the expiry date and time for the SMP credentials (provided that there are no pending transactions to be processed in relation to these credentials).

The issuer response data is forwarded to the payment device 116, at step 1012, indicating the success of the ISO 8583 transaction for the selected payment card. Alternatively, if the transaction is denied by the issuer 142, or the transaction information provided by the payment device 116 indicates a transaction value which exceeds the maximum transaction limit, or corresponding SMP initiation request data cannot be obtained for the payment account identifier and security code token pair (indicating that the SMP transaction is not permitted to be performed with respect to the payment card), then a response indicating the failure of the transaction is sent to the payment device 116 directly following steps 1004, 1006, or 1008.

The payment device 116 receives the transaction response data from the card entity 122 at step 920 and finalises the payment transaction. If the response indicates that the payment transaction was performed successfully by the issuer 142, then finalisation of the payment transaction involves the approval of the ATM withdrawal or POS purchase. Otherwise, the withdrawal or POS purchase is denied. A notification of the payment transaction completion status is provided to the user 101 via an output device of the terminal 120 (such as, for example, a display screen).

Many modifications will be apparent to those skilled in the art without departing from the scope of the present invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A user device, including at least one computing device being configured to make a payment from a payment card by carrying out the steps of:
generating, at the user device, payment card data representing a payment card linked to a payment account of a user, said payment card associated with a card entity and issued by an issuing financial institution;
processing, at the user device, the payment card data to generate mobile payment initiation request data requesting mobile payment credentials data for performing a transaction with the payment account; and
transmitting, to a card entity server, the mobile payment initiation request data, such that the mobile payment credentials data are received at the user device,
wherein the transaction can be performed at a payment device when a payment account identifier and a corresponding dynamically generated security code, both of the mobile payment credentials data, are presented to the payment device.

2. The user device of claim 1, wherein the payment card data includes an indication of one or more of: the card number; the card entity; and identification information of the user.

3. The user device of claim 1, wherein the payment card data is generated based on a selection of the payment card from one or more mobile payment cards of the user including:
transmitting, to the card entity server, a request for mobile payment card data;
receiving, from the card entity server, a mobile payment card list data that indicates the set of payment cards of the user for which mobile payments can be performed; and
displaying, on the user device, the mobile payment card list data.

4. The user device of claim 3, wherein the mobile payment card list data includes, for each payment card: the card number; an indication of the issuing financial institution; and the card ICA value of the payment card, and the mobile payment initiation request data includes: the payment card data; mobile payment parameter data indicating the parameters of the mobile payment credentials data; and identification data identifying the user.

5. The user device of claim 4, wherein the mobile payment parameter data includes:
an expiration time period indicating a length of time for which the mobile payment credentials are valid for performing the transaction;
a transaction number limit value indicating the maximum number of transactions that can be performed on the payment account using the mobile payment credentials; and
a transaction amount limit value, indicating the maximum value of a transaction performed with the payment account using the mobile payment credentials.

6. The user device of claim 1, wherein the payment identifier is a first QR code, the first QR code generated by the card entity and containing the information of the payment account of the user, the information of the payment account of the user includes one or more of: the name of the user; a Personal Account Number (PAN) of the payment account; an expiration date of the payment card; and a verification value of the payment card.

7. The user device of claim 1, wherein the security code is one of: the PIN code of the payment card; and a one time PIN (OTP) code, the OTP being generated by the card entity using an encryption algorithm with an associated OTP generation key to encrypt the PAN value in combination with a seed value, and wherein the payment account identifier and the security code operate as a token pair encapsulating the PAN of the payment account and the PIN of the payment card during the exchanges of data between the card entity and the user device in relation to the payment.

8. The user device of claim 5, wherein the payment account identifier and security code expire after a predetermined period of time, such that, once the payment account identifier and security code have expired, the payment transaction cannot be performed at the payment device, when the payment account identifier and the security code are presented to the payment device, the predetermined period of time being the expiration time period of the mobile payment parameter data.

9. A card entity system, including at least one computing device being configured to authorise a mobile payment initiation request by carrying out the steps of:
receiving, from a user device, mobile payment initiation request data requesting mobile payment credentials data for performing a transaction with a payment account of a user, said payment account linked to a payment card associated with a card entity and issued by an issuing financial institution;
processing the received mobile payment initiation request data to generate mobile payment credentials data for performing a transaction with the payment account; and
transmitting, to the user device, the mobile payment credentials data, such that the payment can be performed at a payment device when a payment account identifier and a corresponding dynamically generated security code, both of the mobile payment credentials data, are presented to the payment device.

10. The system of claim 9, wherein the payment card is one of one or more payment cards of the user, the process of determining the mobile payment cards of the user including:
receiving, from a user device, a request for mobile payment card data representing the mobile payment cards of the user;
processing the mobile payment card request data to generate mobile payment card list data that indicates the set of payment cards of the user for which mobile payments can be performed; and
transmitting, to the user device, the generated mobile payment card list data.

11. The system of claim 10, wherein the processing of the mobile payment card request data includes:
processing user identification data to generate payment card data for the payment cards of the user for which mobile payments can be performed, said payment cards being associated with the card entity; and
generating mobile payment card list data representing the payment card data of each of said payment cards of the user,
wherein the payment card data generated for each card includes: the card number; an indication of the issuing financial institution; and the card ICA value of the payment card.

12. The system of claim 9, wherein the user identification data includes one or more of the name, address, telephone number, email, and username of the user.

13. The system of claim 9, wherein the mobile payment initiation request data includes: the payment card data; mobile payment parameter data indicating the parameters of the mobile payment credentials data; and identification data identifying the user, and wherein the mobile payment parameter data includes:
an expiration time period indicating a length of time for which the mobile payment credentials are valid for performing the transaction;
a transaction number limit value indicating the maximum number of transactions that can be performed on the payment account using the mobile payment credentials; and
a transaction amount limit value, indicating the maximum value of a transaction performed with the payment account using the mobile payment credentials.

14. The system of claim 9, wherein the payment identifier is a second QR code, the second QR code generated by the card association entity and containing the information of the payment account of the user, the information of the payment account of the user includes one or more of: the name of the user; a Personal Account Number (PAN) of the payment account; an expiration date of the payment card; and a verification value of the payment card.

15. The system of claim 9, wherein the security code is one of: the PIN code of the payment card; and a one-time PIN (OTP) code, the OTP being generated using an encryption algorithm with an associated OTP generation key to encrypt the PAN value in combination with a seed value.

16. The system of claim 14, wherein the payment account identifier and the security code operate as a token pair encapsulating the PAN of the payment account and the PIN of the payment card during the exchanges of data between the card entity and the user device in relation to the payment.

17. The system of claim 13, wherein the payment account identifier and security code expire after a predetermined period of time, such that, once the payment account identifier and security code have expired, the payment transaction cannot be performed at the payment device, when the payment account identifier and the security code are presented to the payment device, the predetermined period of time being the expiration time period of the mobile payment parameter data.

18. A data processor implemented process for conducting a payment transaction made on a payment card, the process being executed by at least one processor, and including:
receiving, at a card entity server, from a payment device:
i) transaction information data representing a payment transaction requested in respect of a payment account of a user, said payment account associated with the payment card; and
ii) payment credentials data representing a payment account identifier of the payment account and a corresponding dynamically generated security code;
processing, at the card entity server, the payment credentials data and the transaction information data to produce validity data indicating whether the payment transaction specified by the transaction information data can be validly performed, the validity data based on an indication of the prior authorisation of the transaction with the payment account;
generating, at the card entity server, if the payment transaction is valid, financial transaction data representing a standard financial transaction message for conducting the payment transaction;
transmitting, from the card entity server, the standard financial transaction message to the issuing financial institution for processing, and receiving corresponding response data indicating the success or failure of the payment transaction; and
transmitting the response data from the card entity server to the payment device to allow completion of the payment transaction.

19. The payment transaction process of claim 18, including:
generating, if the response data indicates a success of the payment transaction, mobile payment transaction record data indicating that the payment transaction has been performed with the payment card.
